(19) United States
(12) Patent Application Publication
(10) Pub. No.: US 2011/0085957 A1
(43) Pub. Date: Apr. 14, 2011

(54) Process for producing scintillation materials of low strain birefringence and high refractive index uniformity

(76) Inventors: Johann-Christoph Von Saldern, Jena (DE); Christoph Seitz, Jena (DE); Lutz Parthier, Kleinmachnow (DE); Jochen Alkemper, Klein-Winterheim (DE)

(21) Appl. No.: 12/899,956

(22) Filed: Oct. 7, 2010

Related U.S. Application Data
(60) Provisional application No. 61/250,110, filed on Oct. 9, 2009.

(51) Int. Cl. C01F 17/00

(52) U.S. Cl. 423/263

(57) ABSTRACT

The process produces a scintillation material of formula LnX₃ or LnX₃:D, wherein Ln is at least one rare earth element, X is F, Cl, Br, or I; and D is at least one cationic dopant selected from the group consisting of Y, Zr, Pd, Hf and Bi. The at least one cationic dopant is present in the scintillation material in an amount of 10 ppm to 10,000 ppm. The process includes optionally mixing the compound of the general empirical formula LnX₃ with the at least one cationic dopant, heating the compound or the mixture obtained by the optional mixing to a melting temperature thereof, then growing the crystal or crystalline structure and cooling the resulting crystal or crystalline structure from a growing temperature to a temperature of 100° C. at a cooling rate of less than 20 K/h.

### CROSS-REFERENCE

The invention claimed and described herein below is also described in U.S. Provisional Application 61/250,110, filed on Oct. 9, 2009. The aforesaid U.S. Provisional Application, whose entire subject matter is incorporated by explicit reference thereto, provides the basis for a claim of priority of invention for the invention described and claimed herein below under 35 U.S.C. 119 (e).

### BACKGROUND OF THE INVENTION

The present invention relates to an improved process for producing scintillation materials. The scintillation material obtained according to the invention has advantageous properties, namely a low strain birefringence (SBR) and high homogeneity of the refractive index (HOM). As a result, the detector properties can be improved. In addition, the materials produced according to the invention exhibit high mechanical ruggedness, particularly when they are doped according to a special embodiment of the present invention.

Prior art scintillation materials often exhibit a significant strain birefringence which leads to poor detector properties. Moreover, the refractive index of the material is not homogeneous which leads to unfavorable light yields. These problematic properties of prior art scintillation materials are also a result of their manufacturing process.

Such manufacturing processes are also disadvantageous, because they give low yields. Finally, in addition to the high requirements in terms of the strain birefringence and the homogeneity of the refractive index, there are other parameters that the scintillation materials must meet. These include, for example, the fracture sensitivity. The scintillation materials obtained by currently known manufacturing processes are fracture-sensitive which in essence is due to inhomogeneity of the material, to thermal strains and to crystal defects.

The mechanical strength of such known materials related to separation, grinding and polishing is thus markedly reduced or the costs are increased. As already stated, the yields of the known processes are low and there are a considerable number of rejects.

The high strain birefringence which the prior art materials are known to have and the refractive index inhomogeneity are deficiencies responsible for the, in part considerable, crystal-to-crystal differences shown by the scintillation properties and mechanical properties.

The process of the present invention, however, is not limited to the production of single crystal scintillation materials, although this constitutes a special embodiment. The invention also makes it possible to produce polycrystalline materials. Preferably, such polycrystalline structures are essentially devoid of interspaces/grain boundaries, which lead to single-crystal-like properties.

Processes for producing single crystal scintillation materials are preferred, because the processes according to the invention are suited for producing single crystals of a preferred size. If the material is polycrystalline, the individual crystals should have a structure allowing them to be arranged so that they can impart isotropic behavior to the material (see above comments).

For example, scintillation materials based on cerium bromide are known from the prior art, see for example U.S. Pat. No. 7,405,404 B1. The cerium bromide discussed therein can also be doped. In particular, yttrium, hafnium, palladium, zirconium and bismuth are not mentioned as dopants. More-over, the processes for producing the single crystal scintillation materials are current processes known to those skilled in the art. Special cooling conditions or cooling rates used during the manufacturing process are not mentioned.

EP 1 930 395 A2 describes scintillator compositions produced from various “pre-scintillator compositions”. Annealing regimes or cooling rates are not discussed.

US2008/0067391 A1 discloses, among other things, single crystal scintillators of a certain formula. It concerns dopants in the material and not a specific manufacturing process that could result in a preferred strain birefringence. The same can be said for US 2008/0011953 A1.

### SUMMARY OF THE INVENTION

Hence, a considerable need exists for a novel manufacturing process for scintillation materials exhibiting a low strain birefringence and a high homogeneity of the refractive index. The process should be flexible in terms of use so that it can produce single crystalline as well as polycrystalline scintillation materials.

If the scintillation material is single crystalline, the process should be able to produce large single crystals.

Moreover, these processes should be able to produce the material in high yields and in a simple manner.

The materials produced by the process of the invention should not only have the advantageous properties described hereinabove, but they should also have much improved mechanical properties.

The process according to the invention should also be flexible regarding the possibility of its being used for production of doped lanthanum halides.

The aforesaid objectives of the present invention are attained by a process according to the appended claims presented herein below.

In particular, these objectives and others, which will be made more apparent hereinafter, are attained in a process for producing a scintillation material which comprises a compound of the general empirical formula LnX₃ or LnX₃:D, wherein Ln is at least one member selected from the group consisting of Sc, Y, La, Ce, Pr, Nd, Pm, Sm, Eu, Gd, Tb, Dy, Ho, Er, Tm, Yb and Lu; X is selected from the group consisting of F, Cl, Br and I; and D is at least one cationic dopant comprising one or more of the elements Y, Zr, Pd, Hf and Bi and is present in the material in an amount of 10 ppm to 10,000 ppm, which process comprises optionally mixing the compound of the formula LnX₃ with the at least one cationic dopant, heating the compound or the mixture made by the optional mixing to the melting temperature of the compound or the mixture, and then growing the crystal or crystalline structure.

According to the invention the process comprises cooling the crystal or crystalline structure from the crystal-growing temperature to a temperature of 100° C. at a cooling rate of less than 20 K/h.

According to one embodiment, the process also comprises the following other steps:
introducing a lanthanum halide optionally containing or not containing a dopant into an appropriate ampoule;
evacuating the ampoule;
optionally sealing the ampoule;
heating the ampoule and then growing a crystal or a crystalline structure;
cooling the crystal or crystalline structure from the growing temperature to a temperature of 100° C. at a cooling rate of less than 20 K/h;
cooling the crystal or the crystalline structure from 100° C. to 25° C. at a cooling rate of less than 40 K/h.

The maximum temperature gradient in the crystal, provided it is a single crystalline material, is at every point of the growing process less than 10 K/cm. According to particularly preferred embodiments this temperature gradient is less than 5 K/cm and most preferably less than 2 K/cm.

According to a preferred embodiment of the process of the invention, the cooling rate within the temperature range between the crystal-growing temperature and about 100° C. is less than 10 K/h and most preferably about 5 K/h.

The further cooling rate within the temperature range between about 100° C. and 25° C. in the process of the invention is a cooling rate of 20 K/h and more preferably 10 K/h.

The process according to the invention is generally usable for the production of scintillation materials having the formula LnX₃, wherein Ln is selected from the group consisting of Sc, Y, La, Ce, Pr, Nd, Pm, Sm, Eu, Gd, Tb, Dy, Ho, Er, Tm, Yb and Lu (i.e. the rare earth elements), and X is F, Cl, Br or I. This process can also be used to produce materials of formula LnX₃:D wherein the preceding definitions apply to Ln, X, and D is at least one cationic dopant comprising one or more of the elements Y, Zr, Hf, Pd and Bi and is present in the material in an amount of 10 ppm to 10,000 ppm. According to the invention, the preferably produced scintillation materials are those consisting of the afore-indicated compound LnX₃ or LnX₃:D.

If the process according to the invention is used to produce doped materials, the dopant can be present in the material in an amount of 10 ppm to 10,000 ppm and optionally up to 5,000 ppm, preferably in an amount of 50 ppm to 1,000 ppm, and more preferably of 100 ppm to 1,000 ppm.

According to the invention, pure cerium bromide is preferably produced by the process described herein. Also in preferred materials lanthanum, lutetium, or praseodymium is the cation. Preferred anions are chloride, bromide, and iodide, the more preferred anions being chloride and bromide.

The cooling rates according to the invention can be used in processes for producing single crystals known to those skilled in the art, for example the Bridgman or Czochralski process. Usually, the starting halides with or without dopants are heated to induce them to melt and are then cooled according to the invention to induce crystallization.

The materials obtained according to the invention distinguish themselves by, among other things, an excellent light yield. The decay time of the scintillation materials is not shortened.

In the case of single crystal materials, it is possible to produce large-volume units greater than 5 cm³ in size, which have the desired low strain birefringence and outstanding refractive index homogeneity according to the invention.

If the materials are doped, the dopant or dopants are present in the scintillation material in an amount of 50 ppm to 5,000 ppm and more preferably of 100 ppm to 1,000 ppm.

The difference in ionic radius between the dopants D and the cations of group Ln leads to local strains in the host crystal. Until now it has been assumed that such local strains are disadvantageous. Surprisingly, however, we have now found that these strains enhance the lattice energy to an extent such that the critical energy for fissuring or fissure propagation is clearly increased.

During the crystal-growing process, these local strains result in fewer structural crystal defects. The thermal strains brought about by the gradients needed for crystal growth are not removed by defects (elastic and not plastic strain degradation). This, as a result of the cooling process of the invention, leads to a lower thermal strain in the crystal.

Moreover, the lower defect concentration brings about a decrease in the non-radiating transitions and thus an increase in light yield or light output without negatively affecting the other scintillation properties, such as the decay time and the energy resolution. A dopant D can be present in the scintillation material produced according to the invention in an amount of 500 ppm to 5,000 ppm. A dopant content of 100 ppm, particularly one higher than 500 ppm, and even one as high as the upper limit of 1,000 ppm, is particularly preferred.

It was found that the scintillation material produced according to the invention has unusually advantageous properties when the element Ln, which is present in cationic form, is selected from the group consisting of La, Ce, Lu, Pr and Eu. Ln is preferably La or Ce.

The anion X is quite preferably Cl, Br, or I and even more preferably is Cl or Br. The most preferred scintillation material according to the invention is doped CeBr₃.

Doped lutetium iodide and doped lanthanum bromide are also preferably produced by the process of the present invention.

The scintillation materials of the above-described compositions produced with the dopants according to the invention are characterized by pronounced hardness, even at temperatures near their melting point. As a result, fewer crystal defects are formed and fewer strains are generated.

In the performance of the process of the invention, during the annealing, a uniform temperature is used, which is at most 10 K, preferably at most 50 K, and more preferably at the most 100 K, below the melting temperature of the material. The temperature gradient is less than 2 K/cm, preferably less than 1 K/cm, and most preferably less than 0.5 K/cm. The heating and cooling rates for the annealing step are to be chosen as for the cooling process.

The scintillation material thus obtained distinguishes itself by a strain birefringence of less than 1 μm/cm, preferably less than 50 nm/cm, and most preferably less than 10 nm/cm. Appropriate annealing not only improves the strain birefringence, but also, and considerably, the homogeneity of the refractive index. PV values better than Δn=10⁻³ can be achieved. Those skilled in the art know that by the PV value is meant the maximum observed difference of the refractive indices. PV is an abbreviation for “peak to valley”.

According to the invention, the background radiation of the scintillation material is less than 0.5 Bq/cm³, which is made possible by the high purity of the material. Impurities that contribute to radioactive background radiation are avoided by selecting starting compounds of adequate purity.

### EXAMPLES

The following examples explain the invention and are not intended to limit its scope.

### Example 1

To prepare a material according to the invention, in a glove box filled with argon, 500 g of cerium bromide was weighed out into a quartz ampoule having an internal diameter of 30 mm, with water and oxygen present in the atmosphere in an amount of less than 5 ppm. The ampoule was then evacuated, filled with argon to 50 mbar and sealed. A 30 mm-long capillary with an internal diameter of 3 mm was inserted into the tip of the ampoule. The ampoule was placed into a 3-zone Bridgman furnace. At first, the temperature was kept at 780° C. for 48 h. Then, a crystal was grown at a withdrawing rate of 1 mm/h. The crystal was then cooled from the growing temperature to a temperature of 100° C. at a cooling rate of less than 10 K/h. The cooling rate was then adjusted to less than 20 K/h until the room temperature was reached. During the entire growing process, the temperature gradient in the crystal was less than 5 K/cm.

The ampoule was then opened in the glove box and the crystal was removed.

### Example 2

To prepare a material according to the invention, in a glove box filled with argon, 500 g of cerium bromide, 0.26 g of BiBr₃ (corresponding to 0.125 g of bismuth) and 0.29 g of HfBr₃ (corresponding to 0.125 g of hafnium) were weighed out into a quartz ampoule having an internal diameter of 30 mm, with water and oxygen present in the atmosphere in an amount of less than 5 ppm. The ampoule was then evacuated, filled with argon to 50 mbar and sealed. A 30 mm-long capillary with an internal diameter of 3 mm was inserted into the tip of the ampoule. The ampoule was placed into a 3-zone Bridgman furnace. At first, the temperature was kept at 780° C. for 48 h. Then, a crystal was grown at a withdrawing rate of 1 mm/h. The crystal was then cooled from the growing temperature to a temperature of 100° C. at a cooling rate of less than 10 K/h. The cooling rate was then adjusted to less than 20 K/h until the room temperature was reached. During the entire growing process, the temperature gradient in the crystal was less than 5 K/cm.

The ampoule was then opened in the glove box and the crystal was removed.

While the invention has been illustrated and described as embodied in a process for producing scintillation materials of low strain birefringence and high refractive index uniformity, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A process for producing a scintillation material, said scintillation material comprising a compound of general empirical formula LnX₃ or LnX₃:D, wherein Ln is at least one member selected from the group consisting of Sc, Y, La, Ce, Pr, Nd, Pm, Sm, Eu, Gd, Tb, Dy, Ho, Er, Tm, Yb and Lu; X is selected from the group consisting of F, Cl, Br and I; and D is at least one cationic dopant comprising one or more element selected from the group consisting of Y, Zr, Pd, Hf and Bi and said at least one cationic dopant is present in the material in an amount of 10 ppm to 10,000 ppm;
said process comprising the steps of:
a) optionally mixing the compound of the general empirical formula LnX₃ with the at least one cationic dopant to obtain a mixture;
b) heating the compound or the mixture obtained by the optional mixing to a melting temperature thereof;
c) then growing the crystal or crystalline structure; and
d) cooling the crystal or crystalline structure obtained by the growing from a growing temperature of the crystal or the crystalline structure to a temperature of 100° C. at a cooling rate of less than 20 K/h.

2. The process according to claim 1, wherein the cooling rate between the growing temperature and 100° C. is 10 K/h or less.

3. The process according to claim 1, wherein the cooling rate between the growing temperature and 100° C. is 5 K/h or less.

4. The process according to claim 1, further comprising cooling the crystal or crystalline structure in a temperature range of 100° C. to 25° C. at a cooling rate of less than 40 K/h and wherein a maximum temperature gradient within the crystal is less than 10 K/cm.

5. The process according to claim 4, wherein the cooling rate in the temperature range of 100° C. to 25° C. is 20 K/h or less.

6. The process according to claim 4, wherein the cooling rate in the temperature range of 100° C. to 25° C. is 10 K/h or less.

7. The process according to claim 1, wherein the crystal or the crystalline structure has a temperature gradient of less than 10 K/cm.

8. The process according to claim 1, further comprising annealing the crystal or the crystalline structure and wherein the crystal or the crystalline structure has a uniform temperature during the annealing.

9. The process according to claim 8, wherein the uniform temperature during the annealing is at the most 10 K below said melting temperature.

10. The process according to claim 8, wherein heating and cooling rates during the annealing are selected as in said cooling of the crystal or the crystalline structure.
